(19) United States
(12) Patent Application Publication
(10) Pub. No.: US 2009/0187426 A1
(43) Pub. Date: Jul. 23, 2009

(54) IMPLANTABLE MEDICAL DEVICE SYSTEM AND METHOD FOR ADAPTING FUNCTIONS OF THE CLINICIAN'S WORKSTATION THEREOF

(76) Inventors: Jürgen Kerstna, Hässelby (SE); Patrik Malmberg, Stockholm (SE); Sven-Erik Hedberg, Kungsängen (SE); Leif Lychou, Spanga (SE)

Correspondence Address: SCHIFF HARDIN, LLP;PATENT DEPARTMENT, 6600 SEARS TOWER, CHICAGO, IL, 60606-6473, US

(21) Appl. No.: 12/301,691

(22) PCT Filed: May 31, 2006
(86) PCT No.: PCT/SE06/00646

§ 371 Date: Nov. 20, 2008

(51) Int. Cl. G06Q 50/00; G06F 17/30

(52) U.S. Cl. 705/3; 707/10; 707/E17.01

(57) ABSTRACT

Functions of a clinician's workstation, which is a part of an implantable medical system that also includes an implantable medical device, are dynamically adapted dependent on collected patient data and/or collected data relating to operation of the implantable medical device. The adaptation can take place based on instructions provided to the workstation from a server, that is supplied with the collected data, and that processes the collected data to produce the instructions.

### BACKGROUND OF THE INVENTION

1. Field of the Invention

The present invention relates to a method for adapting functions of a clinician's workstation in an Implantable Medical Device, IMD, system, said the clinician's workstation communicating with at least one IMD implanted to a patient.

2. Description of the Prior Art

An Implantable Medical Device (IMD) system is a system that includes at least one IMD implanted into a patient and a programmer (or equivalent clinical workstation) communicating wirelessly with the IMD. The programmer is used by a clinician, for example a physician, during patient follow-up to analyze the patient's status and reprogram IMD parameters. The same programmer applications are normally provided to all kind of programmers in all different countries and for all different types of physicians, IMDs and indications. Some rather restricted possibilities to configure the applications are present today but these configurations are typically non intelligent. Normally a static pre-packaged media is used to distribute the software upgrade installation means on the programmer if something needs to be updated or added to the previously distributed applications.

U.S. Pat. No. 6,363,282 describes a method for providing an automated software update to a programmer used in an IMD system. The patent is mainly related to how to assure that the software update is approved by manufacturer and governing body.

The programmer applications in IMD systems today are not adapted for different needs of different patients and physicians. Furthermore it is very expensive to update the programmer every time new disease progression management methods and scientific findings become known and could be used for improved decision making.

### SUMMARY OF THE INVENTION

An object of the present invention is to provide a flexible and improved IMD system.

In accordance with the invention, the functions of the clinician's workstation are dynamically adapted based on the patient state. This adaptation can be performed automatically each time the patient comes to a clinic for a medical examination or treatment. The treatment of the patient can be more individually adapted and can also be changed very flexible over time.

### BRIEF DESCRIPTION OF THE DRAWINGS

FIG. 1 shows schematically an IMD system according to an embodiment of the invention.

FIG. 2 shows schematically the components of a clinician's workstation and a server according to an embodiment of the invention.

FIG. 3 is a flowchart of the method steps according to an embodiment of the invention.

### DESCRIPTION OF THE PREFERRED EMBODIMENTS

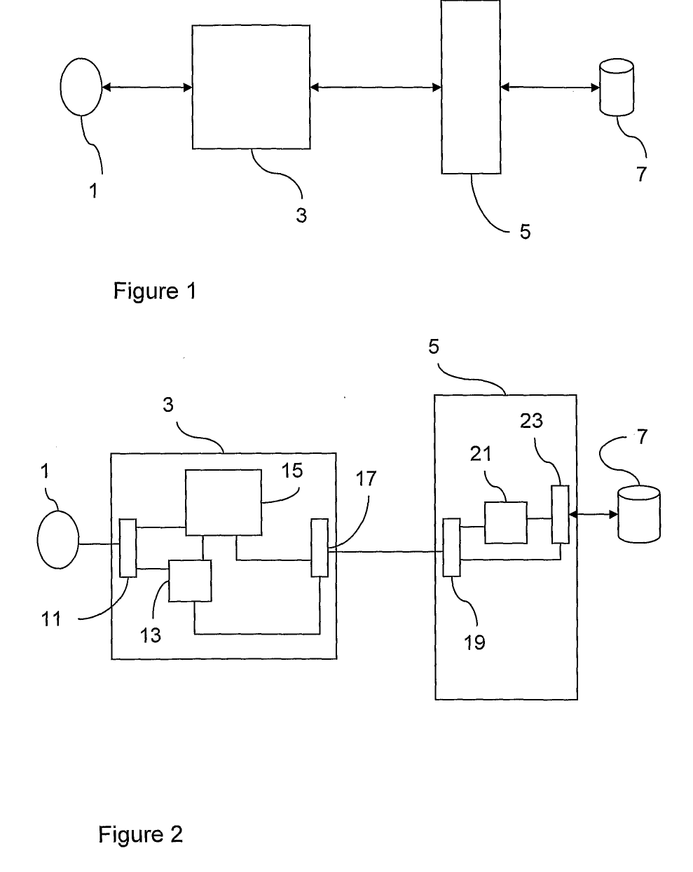

FIG. 1 is a schematic view of an Implantable Medical Device, IMD, system according to one embodiment of the invention. An IMD 1 is shown. This could be any type of IMD, for example a pacemaker, an implantable diagnostic unit, an Implantable Cardiac Device, ICD, or any other Implantable Cardiac Rhythm Management Device. The IMD can communicate wirelessly with a clinician's workstation 3. The clinician's workstation could for example be a programmer or a laptop or a PDA comprising communication means for communicating with IMDs. When we talk about a clinician and a clinician's workstation in this text we normally mean a physician or a nurse or another clinic staff but it could also be the patient himself or someone in his home if a home care or remote care system is used. In this embodiment of the invention the clinician's workstation 3 can also communicate with a server 5. This communication can be wired or wireless, over the public Internet or VPN or over any available physical media using a method with sufficient level of security. Furthermore a knowledge base 7 is shown communicating with the server 5.

According to the invention, functions in the clinician's workstation should be dynamically adapted in dependence of different patient states. Patient states can be different conditions of the patient, such as a stable condition, a changing condition or an emergency condition. Patient data and possibly also IMD device data to be used for an evaluation of a patient state can be received in the clinician's workstation from for example the IMD or it could be entered in by a clinician. The adaptation of functions of the clinician's workstation could be for example changes in a workflow used by the clinician to perform the treatment and interact with the IMD, new or updated algorithms for tests and diagnostics, recommendations to the clinician of adjustments to be made to settings in the IMD, interrogation of more data from the IMD or changes in the user interface shown to the clinician from the clinician's workstation. Different recommendations for treatment could for example be shown to the clinician for different patient states. These functions are suitably adapted by adapting the corresponding software applications of the clinician's workstation. New software that has been adapted in dependence of different patient states and possibly comprising active components is suitably received in the clinician's workstation.

In this embodiment the clinician's workstation 3 further communicates with a server 5. The patient data and possibly also IMD data are forwarded to the server 5 and the data are analyzed in the server 5. In this embodiment the server further retrieves other patient data for analysis from a knowledge base 7. The server can compare new patient data with stored patient data and possibly also with predefined models and threshold values for comparison in order to derive adaptations to be sent to the clinician's workstation 3. In one embodiment the server can also use an Expert System for doing the analysis. The server can for example be a web-application server. The functions of the clinician workstation should be adapted dynamically and possibly each time new patient data has been forwarded from the clinician's workstation to the server. Hereby the functions can be adapted many times during the same patient follow-up.

In another embodiment the analysis of the patient data can be performed inside the clinician's workstation. For example an application server can download an intelligent component like applet or ActiveX control to the workstation and thereby the analysis can be performed in the workstation whereas the component is dynamically selected or even constructed and assembled at the server. In another example the workstation has a pre-installed module that includes a rule engine. The server generates rules and sends them to the workstation, where the engine executes the rules.

FIG. 2 is a schematic view of a clinician's workstation and a server according to one embodiment of the invention. The clinician's workstation has an IMD communication unit 11 adapted to communicate wirelessly with at least one IMD implanted into a patient. Furthermore it has a patient data receiving unit 13 connected to the communication unit 11. The patient data receiving unit 13 is adapted to receive patient data and possibly also IMD data from for example the IMD. The patient data could be for example measurement values such as blood pressure, activity, oxygen saturation, blood temperature, stroke volume, dP/dt, cardiac output, respiration rate or registered episodes from the IMD. The IMD data could be information from the IMD about the IMD performance such as pacing statistics, battery depletion data or lead impedance. The patient data receiving unit 13 could also receive patient data from other external measurement equipment or data sources, such as cardiac output, ECG, Non-invasive blood pressure, X-Ray/MR/CT/US and blood gas analyzer. Patient data can also be entered into the clinician's workstation by a clinician. Functions necessary for the interaction between a clinician and the system are provided in a functions unit 15 in this illustration. Therefore the patient data receiving unit 13 is connected to the functions unit 15. The clinician can fill in other measurement values related to the patient or possibly also a personal judgment made by the clinician about the condition of the patient.

The patient data receiving unit 13 is in this embodiment further connected to a server communication unit 17. The server communication unit 17 is adapted to communicate with a clinician's workstation communication unit 19 in a server 5 as described above. The server communication unit 17 forwards patient data retrieved from the patient data receiving unit 13 to the clinician's workstation communication unit 19 in the server 5. The server 5 further has a function adapter 21 for deriving adaptations to the functions of the clinician's workstation. This function adapter 21 is connected to the clinician's workstation communication unit 19. The function adapter 21 analyzes the received patient data and derives adaptations to the functions to be sent to the clinician's workstation 3. In this embodiment the function adapter 21 is also connected to a knowledge base communication unit 23 adapted to communicate with a knowledge base 7. The knowledge base 7 is a data base with knowledge about how the system can be adapted depending on different patient states. The knowledge base 7 can also contains data related to the patients. The knowledge base 7 can also retrieve further patient information from an Electronic Health Record, EHR, system. The knowledge base communication unit 23 is in this embodiment adapted to retrieve adaptation instructions and forward it to the function adapter 21. The knowledge base communication unit 23 is furthermore adapted to receive new patient data from the clinician's workstation communication means and forward these data for storing in the knowledge base 7. The function adapter 21 can in one embodiment of the invention compare the patient data with previously stored models relating to different patient state categories. The function adapter 21 can, by using preset comparing values related to different patient state categories, classify the patient into one of these categories. If the clinician also has provided his or her own opinion about the patient condition or possibly his or her own categorization of the patient, this is also used for the classifying of the patient. This categorization of the patient can alternatively be performed in the knowledge base 7 or with the help of the knowledge base 7. To summarize, in this embodiment, the function adapter 21 analyzes the received patient data in order to classify the patient in question into a predefined patient state category. Depending on which category the patient is classified to belong to, different adaptations are sent back to the clinician's workstation.

As noted above it would also be possible to use an Expert System for doing the analysis of patient data.

The adaptations to the functions are forwarded to the functions box 15 in the clinician's workstation 3. In one embodiment it could be suitable to show the adaptations to be done to the clinician before performing the actual adaptations. The clinician can then take a decision of which adaptations that should be performed. The adaptations are then implemented. An example of adaptation of the information being displayed to the clinician is discussed below in the heart failure example. Another example could be that the user interface can be adapted for different patient states or also for different kind of clinicians. A workflow controlling means in the functions box 15 could also be adapted such that the workflows involved in the interaction between the clinician and the IMD system can be changed according to different patient states.

The functions unit 15 is also directly connected to the IMD communication unit 11 in order to communicate any changes to the IMD.

As noted above the server can be a web-application server in one embodiment of the invention. In this case the clinician's workstation comprises a web-browser for retrieving adapted functions in the form of active web-pages from the web-application server. The web-browser is in this case comprised in the functions unit 15 of FIG. 2. The functions that are adapted in this case is thus information being shown on the web-pages to the clinician and possible further activities initiated from these web-pages by activating embedded software objects.

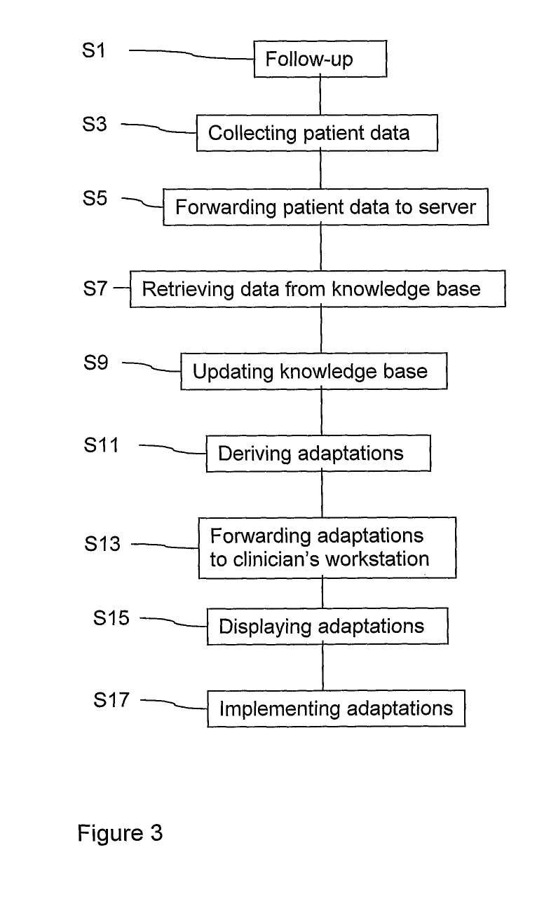

FIG. 3 is a flowchart of a general example according to the invention. The process steps are described in order below:

S1: A patient having an IMD implanted comes to a clinic for a follow-up/treatment.

S3: Patient data are collected in the clinician's workstation. For example patient data, such as measurements performed by the IMD and information about other conditions such as pacing statistics and battery status of the IMD are transferred wirelessly from the IMD to the clinician's workstation. Other patient data can also be collected, such as for example a personal opinion from the clinician examining the patient or measurement values from other measurement devices.

S5: The patient data are in this embodiment forwarded to a server.

S7: Possibly the server can retrieve stored patient data and possibly also instructions about how functions can be adapted in dependence of different patient states from a data base. The stored patient data can be previously received IMD patient data and possibly also other types of information about this patient, for example how the patient reacts on different kinds of treatment and medicines. Information could also possibly be retrieved about which medication the patient is using at present.

S9: If a knowledge base is used this knowledge base should preferably also be updated with all new patient data received in the server.

S11: The server is deriving adaptations of the functions in the clinician's workstation. The adaptations can be based on different predefined models or threshold values for comparison. These models or border values can be provided either in the server or in the knowledge base. The patient data is compared with the predefined models or threshold values and the patient is classified into a patient state category for which certain adaptations of certain functions have been predefined. The adaptations are forwarded to the clinician's workstation.

S13: The adaptations are received in the clinician's workstation.

S15: Possibly the adaptations are shown to the clinician and the clinician can make a decision about which adaptations that should be implemented.

S17: The functions are adapted according to the decision made by the clinician or possibly if the clinician not is involved according to the adaptations sent from the server.

An adapted web-page is for example displayed to the clinician if the system implementation comprises an application/web server and a browser based thin client workstation. The web-page comprises for example instructions to be shown to the clinician where said instructions have been adapted to different patient states. If the clinician makes some new inputs regarding the patient state or if some new measurements relating to the patient state are retrieved these patient data are forwarded to the server and the adaptation of functions is performed again, i.e. the process is repeated from S3. Such an adaptation of functions in the clinician's workstation can be performed every time the patient comes to the clinic and a communication is initiated between the IMD and the clinician's workstation, i.e. the process is repeated from S1. Hereby the functions of the clinician's workstation are constantly and dynamically adapted during treatment of the patient.

### Heart Failure Example:

How a more detailed example will be given where heart failure is detected and the clinician's workstation is adapted accordingly.

1. An IMD in a patient measures heart failure indications from special sensors.

2. During follow-up the clinician's workstation interrogates the measurements from the IMD.

3. The clinician's workstation forwards the measurements to a server, which in this example is a web-application server.

4. The server utilizes an Expert System which runs analysis of the measurements.

5. Based on the results from the Expert System, the server generates an interactive displayable information page to be sent to the clinician's workstation. This information page informs about possible emerging conditions of heart failure. The clinician's workstation runs browser based thin client applications capable of presenting interactive displayable information pages.

6. The clinician's workstation displays the page to the clinician. This step is thus an adaptation of functions in the clinician's workstation based on patient state. Depending on what kind of patient data that was retrieved from the IMD different information pages will be shown to the clinician.

7. The clinician can in this example navigate the page to request more information from the IMD.

8. A component that was embedded on the page initiates an interrogation of pacing statistics from the IMD when the clinician has requested more information.

9. The new pacing statistics are transferred to the server.

10. The server now utilizes an Electronic Health Record, EHR, system in the primary clinic of the patient to retrieve the patient's medication list.

11. The Expert System runs analysis on the pacing statistics data and the medication information.

12. Depending on the results of the analysis, the server generates a new displayable page with conclusions and recommendations. For example:
Reprogram the IMD with following parameter values.
The problem is not caused by IMD settings but patient is developing heart failure. Contact primary physician.

13. The server sends the page to the clinician's workstation and the clinician's workstation displays it to the clinician.

In this example the functions that are adapted in dependence of different patient states is thus what is displayed to the clinician and retrieving of new measurement values from the IMD.

Example with Two Different Patient States

1. During follow-up the clinician's workstation interrogates the IMD and forwards the patient data to the server.

2. The server makes a classification of the patient. In this example the patient is classified to be either stable or changing.

3. The two states stable and changing correspond to two different modes of care. Depending on the mode of care, the server generates different interactive displayable pages to be presented to the clinician on the screen of the clinician's workstation.

4a. If the patient is classified to be in a stable state, the server generates a sequence of interactive displayable pages, which lead the clinician through the following steps to perform the following functions:
check clinical alerts
check battery status and lead impedances
check stored episodes, rate histograms and mode switches data since previous follow-up
perform capture, sensing tests
evaluate rate control (activity sensor)

4b. If the patient is classified to be in a changing state, the state is further sub-classified as progressive heart failure symptoms. The server generates a sequence of interactive displayable pages, which lead the clinician through the steps in the stable state and also additional pages for extended diagnostics:
check clinical alerts
check battery status and lead impedances
check stored episodes and mode switches data since previous follow-up
check fluid retention in the lungs (pulmonary edema progression) by inspection of bio-impedance trends
check contractility, stroke volume, cardiac output
check rate histograms data since previous follow-up
consider amount of V pacing. Try minimizing V pacing by use of V pacing minimization algorithm VIP
perform capture, sensing tests
in a CRT device, optimize W delays
evaluate rate control (activity sensor)

In this example different pages were shown to the clinician depending on which state the patient was classified to belong to and different instructions were thus provided to the clinician.

Although modifications and changes may be suggested by those skilled in the art, it is the intention of the inventors to embody within the patent warranted heron all changes and modifications as reasonably and properly come within the scope of their contribution to the art.

We claim as our invention:

1-25. (canceled)

26. A method for adapting functions of a clinician's workstation in an implantable medical device system that includes at least one implantable medical device implanted in a patient, comprising the steps of:
at the clinician's workstation, collecting collected data selected from the group consisting of patient data and data relating to operation of said implantable medical device; and
automatically dynamically adapting functions of the clinician's workstation dependent on said collected data.

27. A method as claimed in claim 26 comprising:
from said collected data, dividing an indication of a status of said patient; and
automatically dynamically adapting said functions of said clinician's workstation dependent on said patient status.

28. A method as claimed in claim 26 comprising:
forwarding said collected data from said clinician's workstation to a server in communication with said clinician's workstation;
at said server, processing said collected data to produce instructions for adapting said functions of said clinician's workstation dependent on said collected data; and
transmitting said instructions from said server to said clinician's workstation and dynamically adapting the functions of the clinician's workstation according to said instructions.

29. A method as claimed in claim 28 wherein the step of collecting said collected data includes periodically collecting new patient data, and wherein the step of forwarding said collected data to said server comprises forwarding said collected data, including said new patient data, to said server upon each occurrence of collection of new patient data.

30. A method as claimed in claim 26 comprising collecting said collected data at said clinician's workstation from a source selected from the group consisting of said implanted medical device, a clinician, external measurement equipment that interacts with the patient, and data sources remote from said clinician's workstation.

31. A method as claimed in claim 26 wherein said collected data include said patient data, and comprising:
classifying said patient data into different patient status category; and
dynamically adapting said functions of said clinician's workstation differently for each of said patient status categories.

32. A method as claimed in claim 26 wherein said collected data include patient data, and comprising:
making said data available to a clinician to generate a categorization of a patient status of said patient made by said clinician; and
dynamically adapting said functions of said clinician's workstation according to said patient status categorization.

33. A method as claimed in claim 26 wherein the step of collecting said collected data comprises retrieving stored patient data from a knowledge base, and acquiring new patient data, and using the stored patient data in combination with said new patient data to dynamically adapt the functions of the clinician's workstation, and updating said knowledge base with said new patient data.

34. A method as claimed in claim 26 comprising:
deriving a patient status of said patient from said collected data; and
providing different displayable pages at said clinician's workstation respectively for different patient statuses; and
respectively dynamically adapting said pages, as said functions of said clinician's workstation, dependent on said patient statuses derived from said collected data.

35. A method as claimed in claim 26 comprising dynamically adapting a function of said clinician's workstation dependent on said collected data, selected from the group consisting of at least one new test to be performed on said patient, an updated test to be performed on said patient, an algorithm for interpreting data from said implanted medical device, a user interface, and a workflow of treatment being administered to the patient by said implantable medical device.

36. A clinician's workstation for adapting functions of a clinician's workstation in an implantable medical device system that includes at least one implantable medical device implanted in a patient, comprising:
a data reception unit that collects collected data selected from the group consisting of patient data and data relating to operation of said implantable medical device; and
a processor configured to automatically dynamically adapt functions of the clinician's workstation dependent on said collected data.

37. A clinician's workstation as claimed in claim 26 wherein said processor is configured to, from said collected data, divide an indication of a status of said patient, and to automatically dynamically adapt said functions of said clinician's workstation dependent on said patient status.

38. A clinician's workstation as claimed in claim 36 comprising:
a server communication unit configure to forward said collected data from said clinician's workstation to a server in communication with said clinician's workstation, and to receive instructions from said server, that were produced at said server from said collected data for adapting said functions of said clinician's workstation dependent on said collected data, and to provide said instructions to said processor, said processor being configured to dynamically adapt the functions of the clinician's workstation according to said instructions.

39. A clinician's workstation as claimed in claim 38 wherein said data reception unit is configured to periodically collect new patient data, and wherein said server communication unit is configured to forward said collected data, including said new patient data, to said server upon each occurrence of collection of new patient data.

40. A clinician's workstation as claimed in claim 36 wherein said data reception unit is configured to receive collected data from a source selected from the group consisting of said implanted medical device, a clinician, external measurement equipment that interacts with the patient, and data sources remote from said clinician's workstation.

41. A clinician's workstation as claimed in claim 36 wherein said collected data include said patient data, and wherein said processor is configured to classify said patient data into different patient status category, and to dynamically adapt said functions of said clinician's workstation differently for each of said patient status categories.

42. A clinician's workstation as claimed in claim 36 wherein said collected data include patient data, and wherein:
said data reception unit is configured to receiver a categorization of a patient status of said patient made by a clinician; and
said processor is configured to dynamically adapt said functions of said clinician's workstation according to said patient status categorization.

43. A clinician's workstation as claimed in claim 36 wherein said data collection unit is configured to retrieve stored patient data from a knowledge base, and to receive new patient data, and wherein said processor is configured to use the stored patient data in combination with said new patient data to dynamically adapt the functions of the clinician's workstation, and to update said knowledge base with said new patient data.

44. A clinician's workstation as claimed in claim 36 comprising a display, and wherein said processor is configured to derive a patient status of said patient from said collected data, and to provide different displayable pages at said display respectively for different patient statuses, and to respectively dynamically adapt said pages, as said functions of said clinician's workstation, dependent on said patient statuses derived from said collected data.

45. A clinician's workstation as claimed in claim 36 wherein said processor is configured to dynamically adapt a function of said clinician's workstation dependent on said collected data, selected from the group consisting of at least one new test to be performed on said patient, an updated test to be performed on said patient, an algorithm for interpreting data from said implanted medical device, a user interface, and a workflow of treatment being administered to the patient by said implantable medical device.

46. A server comprising:
a server input configured for communication with a clinician's workstation of an implantable medical device system, that also includes an implantable medical device, to receive collected data from said clinician's workstation selected from the group consisting of data concerning a patient in whom the implantable medical device is implanted, and data concerning operation of the implantable medical device;
a processor configured to analyze said collected data to derive instructions therefrom for dynamically adapting functions of the clinician's workstation dependent on said collected data; and
a forwarding unit configured to forward said instructions from said server to said clinician's workstation.

47. A server as claimed in claim 46 wherein said collected data include patient data, and wherein said processor is configured to derive said instructions by classifying said patient data into one of a number of predetermined patient status classes; and to generate said instructions dependent on the classification of said patient data.

48. A server as claimed in claim 46 wherein said server has access to stored patient data from a knowledge base, and wherein said processor is configured to derive said instructions using stored data retrieved from said knowledge base together with said collected data.

49. A server as claimed in claim 46 wherein said forwarding unit is configured to formulate and forward said instructions as adapted software for operating said clinician's workstation.

50. A server as claimed in claim 46 wherein said processor is configured to generate different displayable pages respectively containing different information dependent on different patient statuses derived from said collected data, and to formulate said instructions as a designation as to which of said displayable pages is to be displayed at said clinician's workstation.

51. A server as claimed in claim 46 wherein said processor is configured to formulate said instructions as instructions selected from the group consisting of instructions to execute a new test on the patient, instructions to execute an updated test on the patient, instructions for interpreting data from said implantable medical device, instructions for adapting a user interface of said clinician's workstation, and instructions for adapting a workflow of a treatment administered by said implantable medical device.
